(19) United States
(12) Patent Application Publication
(10) Pub. No.: US 2026/0227217 A1
(43) Pub. Date: Aug. 6, 2026

(54) MAGNETICALLY INDUCTIVE FLOWMETER, TEMPERATURE MEASUREMENT ARRANGEMENT, AND FLOWMETER HAVING A TEMPERATURE MEASUREMENT ARRANGEMENT OF THIS KIND

(71) Applicant: IFM ELECTRONIC GMBH, Essen (DE)

(72) Inventor: Patrick WERNER, Stetten (DE)

(73) Assignee: IFM ELECTRONIC GMBH, Essen (DE)

(21) Appl. No.: 19/150,384

(22) PCT Filed: Mar. 8, 2024
(86) PCT No.: PCT/EP2024/056233

§ 371 Date: Jul. 23, 2025

(30) Foreign Application Priority Data
Mar. 10, 2023 (DE) 10 2023 106 043.0

(51) Int. Cl. G01F 1/58; G01F 15/14; G01K 1/14; G01K 13/02

(52) U.S. Cl. CPC G01F 1/584; G01F 15/14; G01K 1/14; G01K 13/02

(57) ABSTRACT

A magnetically inductive flowmeter includes measurement electrodes having at least a main body and an electrode head, which is in contact with a medium and has a conical outer contour directed toward the medium. For hygienically reliable sealing of the measurement electrodes, the electrode head of each measurement electrode is arranged in an opening in a wall of a measurement tube, and a sealing element having a conical inner contour is located between the electrode head and the wall of the measurement tube, wherein the outer contour of the electrode head and the inner contour of the sealing element are at an angle to one another, so that maximum compaction of the sealing element takes place exclusively in a quasi-linear sealing region facing the medium. A temperature measurement assembly and a flowmeter having the temperature measurement assembly are included.

The invention relates to a magnetically inductive flowmeter in accordance with the preamble of claim 1, a temperature measurement assembly in accordance with the preamble of claim 11, and a flowmeter in accordance with the preamble of claim 21.

Magnetically inductive flowmeters, the operation of which is based upon the principle of electromagnetic induction (=Faraday induction), have been known for many years and are used extensively in industrial measurement technology. According to the law of induction, in a flowing medium that carries charge carriers and flows through a magnetic field, an electric field strength is created perpendicular to the flow direction and perpendicular to the magnetic field. The law of induction is exploited in magnetically inductive flowmeters by generating a magnetic field by means of a magnetic field generation device, which usually has two energized magnetic coils, which magnetic field is guided, at least in part, through the measurement tube, wherein the generated magnetic field has at least one component which is perpendicular to the flow direction. Within the magnetic field, each volume element of the flowing medium moving through the magnetic field and containing a certain number of charge carriers contributes to a measurement voltage that can be tapped via the electrodes and has the field strength generated in this volume element.

Since the induced voltage tapped via the electrodes is proportional to the flow velocity of the medium averaged over the cross-section of the measurement tube, the volume flow can be determined directly from the measured voltage if the diameter of the measurement tube is known. The only prerequisite for using a magnetically inductive flowmeter is a minimum conductivity of the medium. In addition, it must be ensured that the measurement tube is filled with the medium at least to the extent that the level of the medium is above the measurement electrodes.

Such measurement devices are well known, e.g., from the German patent specifications DE 10 2007 004 827 B4 and DE 10 2007 004 826 B4, and are substantially characterized in that the magnetic coils and the electrodes are arranged directly on or in the wall of the measurement tube.

The measurement electrodes usually consist of a cylindrical main body and an electrode head which is in contact with the medium. The electrode head is typically mushroom-shaped or conical, as is known, for example, from DE 10 2015 112 018 B3 or DE 10 2021 127 943 B3, but can also have a conical outer contour directed toward the medium, as is known from CN 2 09 197 811 U.

In addition to flow measurement, it may also be necessary to measure the temperature of the flowing medium in order to compensate for temperature influences. It is well known that temperature has a considerable influence on the physical and chemical properties of the medium, which in turn can influence the measurement result. If the temperature of the medium is known, appropriate correction factors can be determined which make the measurement results comparable under different temperature conditions.

For example, the German patent DE 10 2010 001 993 B4 discloses a magnetically inductive flowmeter with a temperature measurement apparatus, wherein, in addition to the temperature measurement, a measurement of a minimum conductivity is also possible.

The temperature sensors usually consist of a cylindrical main body and a sensor head which is in contact with the medium. The electrode head is typically mushroom-shaped, as is known, for example, from DE 10 2021 127 942 A1.

In order to avoid a short circuit between the two measurement electrodes on the one hand and to meet the requirements of applications in the pharmaceutical and food industries on the other, it is known from the prior art that the measurement tube is lined or coated on the inside with a liner made of PFA or PTFE, for example. These materials are comparatively soft, so that, as can be seen, for example, from FIG. 3 of DE 10 2021 127 943 B3, during assembly, the measurement electrodes, i.e., the undersides of the electrode heads, are drawn into the soft material, and thus a hygienic seal of the measurement electrodes against the measurement tube is realized. The same sealing concept is also used when a pin-shaped temperature sensor is arranged in such a measurement tube of a flowmeter, since, in addition to measuring the flow, the medium temperature is often also of interest. Such a temperature sensor is known, for example, from DE 10 2021 127 942 A1.

A hygienic seal meets the requirements at least according to EHEDG or 3A and is characterized in particular by the absence of gaps and dead spaces in the region of the transition between the electrode head and the measurement tube or liner.

The object of the invention is to propose an alternative sealing of the measurement electrodes of the magnetically inductive flowmeter or the temperature sensor of a temperature measurement assembly, which sealing is also suitable for hygienic applications.

The object is achieved according to the invention by a magnetically inductive flowmeter having the features of claim 1, by a temperature measurement assembly having the features of claim 11, and by a flowmeter having the features of claim 21. Advantageous embodiments of the invention are specified in the dependent claims.

In a first aspect, the invention relates to a magnetically inductive flowmeter. The focus of the invention is upon measurement electrodes having a main body and an electrode head which is in contact with the medium and has a conical outer contour directed toward the medium. The electrode head of each measurement electrode is arranged in an opening in the wall of the measurement tube.

According to the invention, a sealing element with a conical inner contour is located between the electrode head and the wall of the measurement tube. According to the invention, the outer contour of the electrode head and the inner contour of the sealing element are at an angle to one another, so that maximum compaction of the sealing element takes place exclusively in a quasi-linear sealing region facing the medium. The angle must be selected so that the outer contour and the inner contour approach the medium more and more, i.e., the inner and outer surfaces of the electrode head or sealing element taper toward the medium. With regard to conical contours, it should be noted that this term is not to be interpreted strictly in the mathematical-geometric sense, and therefore slight deviations from a conical shape, e.g., contours with a slight radius, are also to be understood under this term.

If the measurement tube or the inside of the measurement tube consists of a comparatively hard material or is coated, e.g., made of polyether ether ketone (PEEK), the aforementioned quasi-linear sealing region is created in the front region in contact with the medium, and, because the maximum compaction of the sealing element takes place exclusively in this region, the corresponding hygiene guidelines are met. The sealing element is preferably also made of polyether ether ketone (PEEK). However, various other materials for the measurement tube coating are also conceivable. Examples would be enamel/Rilsan/SOL-GEL or other non-conductive coatings. The sealing element can also be made of various thermoplastics or elastomers. Material variants would, for example, be PSU, PPSU, PEI, as well as elastomers such as FKM, EPDM, or silicones or the like.

An advantageous further development provides that a sleeve with a through-bore be arranged in the opening in the wall of the measurement tube, which sleeve is connected to the wall of the measurement tube in a material-locking manner, preferably by welding, and in the through-bore of which the sealing element and the measurement electrode are arranged. The measurement tube and sleeve are preferably made of metal.

A first alternative of this advantageous development provides that the through-bore of the sleeve also have, at least in part, a conical inner contour, and the sealing element have a conical outer contour and be formed with a uniform thickness. The sealing element can thus be made comparatively thin, and the second conical inner and outer contours, which are arranged coaxially, result in a stop during assembly which limits the screw-in depth of the measurement electrode or the electrode head. In this embodiment, too, the outer contour of the sealing element and the inner contour of the sleeve are advantageously at an angle to one another, so that maximum compaction of the sealing element takes place exclusively in the quasi-linear sealing region facing the medium.

In contrast, a second alternative to this advantageous development provides that the through-bore of the sleeve be cylindrical, and the sealing element have a cylindrical outer contour and be stronger in the region of the electrode main body than in the region of the electrode head. An axial stop is preferably achieved here by forming a shoulder in the through-bore of the sleeve, on which shoulder the sealing element rests with its end face opposite the medium. In this embodiment, too, maximum compaction of the sealing element is achieved exclusively in the quasi-linear sealing region facing the medium, in that the sealing element is advantageously arranged with an oversize in the sleeve.

In order to meet the requirements of the relevant hygiene guidelines, e.g., EHEDG or 3A, at least the transitions between the sealing element and the electrode head are flush. If the sleeve described above is present, the transitions between the measurement tube wall and the sleeve as well as between the sleeve and the sealing element are also flush.

For a reliable and permanent mounting of the measurement electrodes on or in the measurement tube, a particularly advantageous development of the invention provides that the main bodies of the measurement electrodes have an external thread at their ends opposite the electrode head, onto which external thread a nut is screwed so that the measurement electrodes are firmly connected to the measurement tube. A spring element is arranged between the measurement tube and the nut coaxially with the longitudinal axis of the measurement electrodes. It is particularly advantageous in this embodiment that the spring element is subjected to a defined preload by screwing on the nut, wherein a limiting element is arranged coaxially with the common longitudinal axis of the spring element and the measurement electrode, which limiting element is suitable for limiting the compaction of the spring element. The preload of the spring element, which is preferably designed as a disc spring, creates a restoring force that ensures the required surface pressure. With the limiting element, the spring force of the spring element can be adjusted, and higher forces can still be transmitted during retraction without exceeding the permissible stresses of the spring element.

In a second aspect, the invention relates to a temperature measurement assembly.

According to the invention, the sensor head of the temperature sensor is arranged in an opening in the wall of the measurement tube and has a conical outer contour directed toward the medium. Furthermore, according to the invention, a sealing element with a conical inner contour is arranged between the sensor head and the wall of the measurement tube. According to the invention, the outer contour of the sensor head and the inner contour of the sealing element are at an angle to one another, so that maximum compaction of the sealing element takes place exclusively in a quasi-linear sealing region facing the medium. The angle must be selected so that the outer contour and the inner contour approach the medium more and more, i.e., the inner and outer surfaces of the sensor head or sealing element taper toward the medium. With regard to conical contours, it should be noted that this term is not to be interpreted strictly in the mathematical-geometric sense, and therefore slight deviations from a conical shape, e.g., contours with a slight radius, are also to be understood under this term.

If the measurement tube or the inside of the measurement tube consists of a comparatively hard material or is coated, e.g., made of polyether ether ketone (PEEK), the aforementioned quasi-linear sealing region is created in the front region in contact with the medium, and, because the maximum compaction of the sealing element takes place exclusively in this region, the corresponding hygiene guidelines are met. The sealing element is preferably also made of polyether ether ketone (PEEK). However, various other materials for the measurement tube coating are also conceivable. Examples would be enamel/Rilsan/SOL-GEL or other non-conductive coatings. The sealing element can also be made of various thermoplastics or elastomers. Material variants would, for example, be PSU, PPSU, PEI, as well as elastomers such as FKM, EPDM, or silicones or the like.

An advantageous further development provides that a sleeve with a through-bore be arranged in the opening in the wall of the measurement tube, which sleeve is connected to the wall of the measurement tube in a material-locking manner, preferably by welding, and in the through-bore of which the sealing element and the temperature sensor are arranged. The measurement tube and sleeve are preferably made of metal.

A first alternative of this advantageous development provides that the through-bore of the sleeve also have, at least in part, a conical inner contour, and the sealing element have a conical outer contour and be formed with a uniform thickness. The sealing element can thus be made comparatively thin, and the second conical inner and outer contours, which are arranged coaxially, result in a stop during assembly which limits the screw-in depth of the temperature sensor or the sensor head. In this embodiment, too, the outer contour of the sealing element and the inner contour of the sleeve are advantageously at an angle to one another, so that maximum compaction of the sealing element takes place exclusively in the quasi-linear sealing region facing the medium.

In contrast, a second alternative to this advantageous development provides that the through-bore of the sleeve be cylindrical and the sealing element have a cylindrical outer contour and be stronger in the region of the temperature sensor main body than in the region of the sensor head. An axial stop is preferably achieved here by forming a shoulder in the through-bore of the sleeve, on which shoulder the sealing element rests with its end face opposite the medium. In this embodiment, too, maximum compaction of the sealing element is achieved exclusively in the quasi-linear sealing region facing the medium, in that the sealing element is advantageously arranged with an oversize in the sleeve.

In order to meet the requirements of the relevant hygiene guidelines, e.g., EHEDG or 3A, at least the transitions between the sealing element and the sensor head are flush. If the sleeve described above is present, the transitions between the measurement tube wall and the sleeve as well as between the sleeve and the sealing element are also flush.

For a reliable and permanent mounting of the temperature sensor on or in the measurement tube, a particularly advantageous development of the invention provides that the main body of the temperature sensor have an external thread at its end opposite the sensor head, onto which external thread a nut is screwed so that the temperature sensor is firmly connected to the measurement tube. A spring element is arranged between the measurement tube and the nut coaxially with the longitudinal axis of the temperature sensor. It is particularly advantageous in this embodiment that the spring element is subjected to a defined preload by screwing on the nut, wherein a limiting element is arranged coaxially with the common longitudinal axis of the spring element and the temperature sensor, which limiting element is suitable for limiting the compaction of the spring element. The preload of the spring element, which is preferably designed as a disc spring, creates a restoring force that ensures the required surface pressure. With the limiting element, the spring force of the spring element can be adjusted, and higher forces can still be transmitted during retraction without exceeding the permissible stresses of the spring element.

In a third aspect, the invention relates to a flowmeter. According to the invention, the flowmeter has a temperature measurement assembly as described above.

The invention is explained in more detail below using exemplary embodiments with reference to the drawings, in which, schematically:

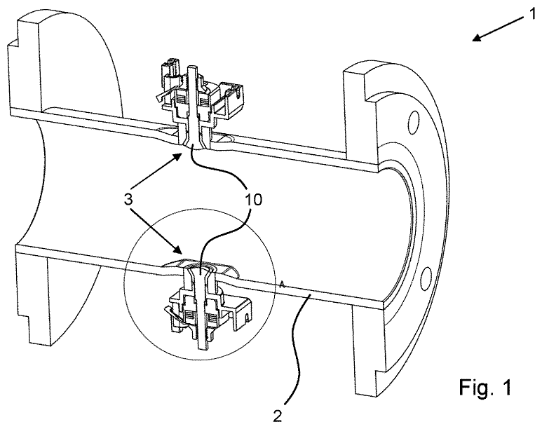

FIG. 1 is a sectional view of a magnetically inductive flowmeter according to the invention or of a temperature measurement assembly according to the invention according to a first embodiment;

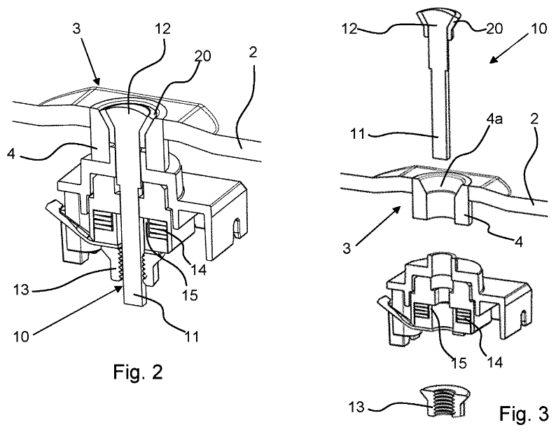

FIG. 2 is an enlarged section of a partial region from FIG. 1;

FIG. 3 is an exploded view of FIG. 2;

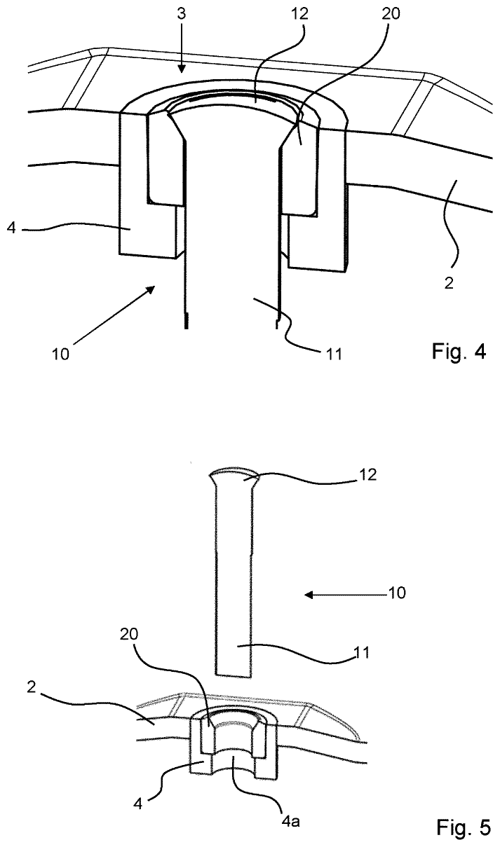

FIG. 4 is an enlarged cutout of a partial region of a magnetically inductive flowmeter according to the invention or of a temperature measurement assembly according to the invention in accordance with a second embodiment;

FIG. 5 is an exploded view of FIG. 4; and

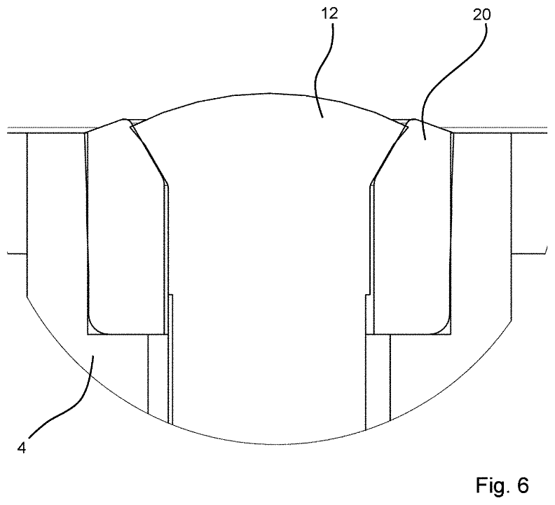

FIG. 6 is an enlarged view of a cutout from FIG. 4.

In the following description of the preferred embodiments, the same reference signs denote the same or comparable components.

Since the structure and functioning of the invention can be applied in the same way to pin-shaped measurement electrodes of a magnetically inductive flowmeter as well as to pin-shaped temperature sensors of a temperature measurement assembly, both applications are considered in parallel below.

FIG. 1 shows a sectional view of a magnetically inductive flowmeter 1 according to the invention, consisting of a measurement tube 2, on each of which a flange is arranged on the end face, and two measurement electrodes 10 with a corresponding structure. However, the magnetic field generation device required for the measurement has not been shown. In the same way, FIG. 1 can also be regarded as a sectional view of a temperature measurement assembly 1 according to the invention, which consists of a measurement tube 2, on which respectively a flange is arranged on the end face, and two temperature sensors 10.

The inside of the measurement tube 2 is coated with a comparatively hard and non-conductive material. PEEK is particularly suitable for this purpose due to its good chemical resistance and suitability for hygienic applications. However, various other materials for the measurement tube coating are also conceivable. Examples would be enamel/Rilsan/SOL-GEL or other non-conductive coatings. In the region of the measurement electrodes 10 or temperature sensors 10, the measurement tube 2 is deformed in order to obtain a flat surface. In the center of this region, there is an opening 3 in which the measurement electrodes 10 or temperature sensors 10 are arranged.

FIG. 2 shows an enlarged view of the region marked “A” in FIG. 1, and FIG. 3 shows an exploded view thereof, each of which shows a first embodiment of the invention.

A sleeve 4 with a through-opening 4a is welded into the opening 3, the media-side surface of which is also coated. The measurement electrode 10 or the temperature sensor 10 with a sealing element 20 is inserted into this sleeve 4. The measurement electrode 10 consists of a cylindrical main body 11 and an electrode head 12, just as the temperature sensor 10 consists of a cylindrical main body 11 and a sensor head 12. In the embodiment as a temperature sensor 10, a temperature sensor (not shown in detail) is arranged on the end face inside the sensor head 12, and is configured, for example, as a PTC or NTC element and is electrically contacted via stranded wires that are guided through the main body 11. The sealing element surrounds the measurement electrode 10 or the temperature sensor 10 substantially only in the region of the electrode head 12 or sensor head 12 and is advantageously also made of PEEK.

It is essential to the invention that the electrode head 12 or sensor head 12 have a conical outer contour and the sealing element 20 have a conical inner contour and both be at an angle to one another, so that, after assembly, maximum compaction of the sealing element 20 takes place exclusively in a quasi-linear sealing region facing the medium, and thus a hygienic seal is achieved. The assembly is substantially carried out by screwing a nut 13 onto the end of the main body 11 opposite the electrode head or sensor head 12. Previously, a spring element 14, which advantageously consists of disc springs, together with a corresponding structure comprising a limiting element 15, has been pushed onto the main body 11. By screwing on and tightening the nut 13, the spring element 14 experiences a defined preload. The limiting element 15, which is arranged coaxially with the common longitudinal axis of the spring element 14 and the measurement electrode 10 or temperature sensor 10, limits the compaction of the spring element 14. The preload of the spring element 14 creates a restoring force that ensures the required surface pressure. With the limiting element 15, the spring force of the spring element 14 can be adjusted, and higher forces can still be transmitted during retraction without exceeding the permissible stresses of the spring element 14.

The first embodiment of the invention shown in FIGS. 2 and 3 is characterized in that the sleeve 4 also has, at least in part, a conical inner contour, and the sealing element 20 also has a conical outer contour. The sealing element 20 can thus be made comparatively thin and with a uniform thickness. The outer contour of the sealing element 20 and the inner contour of the sleeve 4 are also at an angle to one another, so that it is ensured that maximum compaction of the sealing element 20 takes place exclusively in the quasi-linear sealing region facing the medium. Due to the coaxially arranged second conical inner and outer contours, a stop is created during assembly which limits the screw-in depth of the measurement electrode 10 or the electrode head 12 or the temperature sensor 10 or the sensor head 12.

FIGS. 4 and 5 are to be considered analogous to FIGS. 2 and 3 and show a second embodiment of the invention. This is characterized in that the through-bore 4a of the sleeve 4 is cylindrical, and the sealing element 20 has a cylindrical outer contour. In the region of the main body 11, the sealing element 20 is stronger than in the region of the electrode head 12. An axial stop is realized via a shoulder in the through-bore 4a of the sleeve 4, on which shoulder the sealing element 20 rests with its end face opposite the medium. By advantageously arranging the sealing element 20 with an oversize in the sleeve 4, this embodiment also contributes to achieving maximum compaction of the sealing element 20 exclusively in the quasi-linear sealing region facing the medium. In addition, in this embodiment, the coating of the measurement tube 2 can be carried out while the sealing element 20 is already installed. Thus, a continuous coating up to the electrode head or sensor head 12 can be realized.

In all embodiments, it is ensured that at least the transitions between the sealing element 20 and the electrode head or sensor head 12 are flush. If the sleeve 4 is present, the transitions between the measurement tube wall 2 and the sleeve 4 as well as between the sleeve 4 and the sealing element 20 are also flush. This means that the assembly is easy to clean and has no gaps, thus meeting the requirements of the relevant hygiene guidelines.

The front-flush maximum compaction of the sealing element 20 due to the sealing element 20 arranged with an oversize in the sleeve 4 and the outer contour of the sealing element 20 and the inner contour of the sleeve 4 being at an angle to one another are illustrated in FIG. 6, which can also be transferred accordingly to the first embodiment.

### LIST OF REFERENCE SIGNS

1 Magnetically inductive flowmeter, temperature measurement assembly
2 Measurement tube
3 Opening
4 Sleeve
4a Through-opening
10 Measurement electrodes, temperature sensor
11 Main body
12 Electrode head, sensor head
13 Nut
14 Spring element p1 15 Limiting element
20 Sealing element

1. A magnetically inductive flowmeter for measuring the flow of a flowing conductive medium, comprising:
a measurement tube having a non-conductive material having a magnetic field generation device for generating a magnetic field that passes through the measurement tube and is perpendicular to a longitudinal axis of the measurement tube, and having two pin-shaped measurement electrodes for tapping a measurement voltage induced in the flowing medium,
wherein the measurement electrodes are arranged along a connecting line running perpendicular to the longitudinal axis of the measurement tube and perpendicular to the direction of the magnetic field,
wherein each of the measurement electrodes include a main body and an electrode head which is in contact with the medium and has a conical outer contour directed toward the medium,
and wherein the electrode head of each measurement electrode is arranged in an opening) in a wall of the measurement tube, and
a sealing element having a conical inner contour and is located between the electrode head and the wall of the measurement tube, wherein the outer contour of the electrode head and the inner contour of the sealing element are at an angle to one another, so that maximum compaction of the sealing element takes place exclusively in a quasi-linear sealing region facing the medium.

2. The magnetically inductive flowmeter according to claim 1,
wherein a sleeve with a through-bore is arranged in the opening in the wall of the measurement tube, which sleeve is connected to the wall of the measurement tube in a material-locking manner, and in the through-bore of which the sealing element and the measurement electrode are arranged.

3. The magnetically inductive flowmeter according to claim 2,
wherein the through-bore of the sleeve includes a conical inner contour, and the sealing element has a conical outer contour and is formed with a uniform thickness.

4. The magnetically inductive flowmeter according to claim 2,
wherein the through-bore of the sleeve is cylindrical, and the sealing element has a cylindrical outer contour and is thicker in the region of the electrode main body than in the region of the electrode head.

5. The magnetically inductive flowmeter according to claim 4,
wherein the through-bore of the sleeve has a shoulder on which the sealing element rests with an end face opposite the medium.

6. The magnetically inductive flowmeter according to claim 1,
wherein at least transitions between the sealing element and the electrode head are flush.

7. The magnetically inductive flowmeter according to claim 1,
wherein the main bodies of the measurement electrodes have, at ends opposite the electrode head, an external thread onto which a nut is screwed, such that the measurement electrodes are firmly connected to the measurement tube, and a spring element is arranged between the measurement tube and the nut coaxially with the longitudinal axis of the measurement electrodes.

8. The magnetically inductive flowmeter according to claim 7,
wherein the spring element is subjected to a defined preload by screwing on the nut, wherein a limiting element is arranged coaxially with a common longitudinal axis of the spring element and the measurement electrode which limiting element is suitable for limiting the compaction of the spring element.

9. The magnetically inductive flowmeter according to claim 1,
wherein the sealing element is made of a thermoplastic or elastomer, and the measurement tube is lined internally with a liner made of a non-conductive material,
wherein the sealing element and the measurement tube include a polyether ketone (PEEK).

10. (canceled)

11. A temperature measurement assembly for determining a temperature of a medium, with a measurement tube comprising:
a non-conductive material, and
at least one temperature sensor, wherein the at least one temperature sensor includes at least one pin-shaped main body and a sensor head in which the least one temperature sensor is arranged and which is in contact with the medium,
wherein the sensor head is arranged in an opening in a wall of the measurement tube and has a conical outer contour directed toward the medium and wherein a sealing element having a conical inner contour is located between the sensor head and the wall of the measurement tube, wherein the outer contour of the sensor head and the inner contour of the sealing element are at an angle to one another, so that maximum compaction of the sealing element takes place exclusively in a quasi-linear sealing region facing the medium.

12. The temperature measurement assembly according to claim 11,
wherein a sleeve with a through-bore is arranged in the opening in the wall of the measurement tube, which sleeve is connected to the wall of the measurement tube in a material-locking manner and in the through-bore of which the sealing element and the temperature sensor are arranged.

13. The temperature measurement assembly according to claim 12,
wherein the through-bore of the sleeve includes a conical inner contour, and the sealing element has a conical outer contour and is formed with a uniform thickness.

14. The temperature measurement assembly according to claim 12,
wherein the through-bore of the sleeve is cylindrical, and the sealing element has a cylindrical outer contour and is thicker in the region of the main body than in the region of the sensor head.

15. The temperature measurement assembly according to claim 14,
wherein the through-bore of the sleeve has a shoulder on which the sealing element rests with an end face opposite the medium.

16. The temperature measurement assembly according to claim 11,
wherein at least transitions between the sealing element and the sensor head are flush.

17. The temperature measurement assembly according to claim 11,
wherein the main body has, at ends opposite the sensor head, an external thread onto which a nut is screwed, such that the temperature sensor is firmly connected to the measurement tube, and a spring element is arranged between the measurement tube and the nut coaxially with a longitudinal axis of the temperature sensor.

18. The temperature measurement assembly according to claim 17,
wherein the spring element is subjected to a defined preload by screwing on the nut, wherein a limiting element is arranged coaxially with a common longitudinal axis of the spring element and the temperature sensor which limiting element is suitable for limiting the compaction of the spring element.

19. The temperature measurement assembly according to claim 11,
wherein the sealing element is made of a thermoplastic or elastomer, and the measurement tube is lined internally with a liner made of a non-conductive material.

20. The temperature measurement assembly according to claim 19,
wherein the sealing element and the measurement tube include polyether ether ketone (PEEK).

21. A flowmeter for measuring the flow of a flowing medium, having a measurement tube made at least partially of a non-conductive material,
wherein the flowmeter has the temperature measurement assembly according to claim 11.
